(19) United States
(12) Patent Application Publication
(10) Pub. No.: US 2004/0123327 A1
(43) Pub. Date: Jun. 24, 2004

(54) Method and system for managing multimedia settings

(76) Inventors: Tsang Fai Ma, Scarborough (CA); Jitesh Arora, Thornhill (CA)

Correspondence Address: TOLER & LARSON & ABEL L.L.P., 5000 PLAZA ON THE LAKE STE 265, AUSTIN, TX, 78746, US

(21) Appl. No.: 10/326,433

(22) Filed: Dec. 19, 2002

(51) Int. Cl. H04N 7/173

(52) U.S. Cl. 725/100; 725/92; 725/93; 725/98; 725/86

(57) ABSTRACT

A method and system are presented to configure, store, and apply user-selected operating characteristics for multimedia devices on a per-program basis, rather than a per channel or connector-specific basis. The system provides a mechanism to set up and apply user-customized characteristics to a broadcast received on a multimedia device. Operating characteristics which may be selected for setting modification are video characteristics such as brightness, contrast, aspect ratio, resolution, closed-captioning type, parental control features, and others. In addition, audio operating characteristics that are user-selectable for modifications are volume level, language, tone, stereo, surround sound, and so forth. The operating characteristics may include recording options. A current program is identified and the operating characteristics are applied to related multimedia devices.

### FIELD OF THE DISCLOSURE

The present disclosure relates generally to multimedia devices, and more particularly to a method for managing multimedia device settings and preferences

### BACKGROUND

Various multimedia devices such as, televisions, DVD players, video and/or audio recorders, computers, and the like have parameter settings that may be modified for optimization of a listening and/or viewing experience. Consumers have a multitude of multimedia viewing and/or listening choices, however the choice of means for setting the parameters for a diverse combination of multimedia devices is rather limited.

Interactive programming with content or service level systems are known, and permit users (viewers) to select personnel programming service levels. These service level systems, after appropriate set-up by an authorized user, can distinguish content-appropriate programming for a particular viewer. Other functions of these systems include providing viewer-requested programming data by way of an electronic programming guide application, and providing storage and delivery of digitized video information. Typically, these systems do not provide for adjusting the viewing/listening settings, though they can keep track of a user's viewing habits and make viewing suggestions accordingly. For example, these systems attempt to select program content appropriate to the user.

Other interactive entertainment network systems have video-on-demand applications which allow viewers to create their own customized lists or groups of preferred video content programs, e.g., movies, games, television shows, and so forth. These custom groups are stored digitally in mapped locations for quick recall by users.

Systems and methods with enhancements to electronic program schedule guides have also been provided. In addition to displaying program information schedules, enhanced theme or programming features are offered, as well as display of movie listings. The system offers other enhancements such as extending recording time, automatically rescheduling recording, and the like. While some of these systems are capable of customizing properties such as color settings, volume level, and closed captioning, these properties are applied on a per channel basis. However, a single set of properties may not be suitable for the variety of programming provided on a single channel or to particular connector to a multimedia source.

Other systems exist which obtain information with which to automatically adjust parameter settings for audio and video applications used to view video. The information includes the source of the video to be displayed and a general description of the video's content. Initial settings are selected by a user, and are used as a “reference” to all adjustments made to the parameter settings. The system determines optimal parameter settings based on a given program type/genre and specific equipment capabilities, and automatically makes adjustments to those parameters. However, these optimal parameters have been determined within a range of parameters determined for the program content that increase the quality of the viewing as established by the system, not those parameters that are truly optimal for an individual user. A user may choose to override the system's optimized settings in order to manually optimize the parameter settings to suit his or her viewing/listening experience. This, however, defeats the purpose of system determination of optimal parameters.

Therefore, a method is needed to apply customized, user-selected audio and visual properties which overcomes the limitations of the current methods.

### BRIEF DESCRIPTION OF THE DRAWINGS

Other advantages, features and characteristics of the present invention, as well as methods, operation and functions of related elements of structure, and the combination of parts and economies of manufacture, will become apparent upon consideration of the following description and claims with reference to the accompanying drawings, all of which form a part of this specification, wherein like reference numerals designate corresponding parts in the various figures, and wherein:

FIG. 1 is a block diagram illustrating a system for providing user-customized operating characteristics to a program, according to at least one embodiment of the present disclosure;

FIG. 2 is a flow diagram of a method to configure, store, and apply user-selected operating characteristics for multimedia devices on a per-program basis, according to at least one embodiment of the present disclosure;

FIG. 3 is a flow diagram of a method for managing settings applied to a multimedia device according to at least one embodiment of the present disclosure;

FIG. 4 is a simplified block diagram of a system for receiving a digital signal to apply user-selected operating characteristics according to at least one embodiment of the present invention; and

FIG. 5 is a simplified block diagram of a system for receiving an analog multimedia transmission to apply user-selected operating characteristics according to at least one embodiment of the present invention.

### DETAILED DESCRIPTION OF THE FIGURES

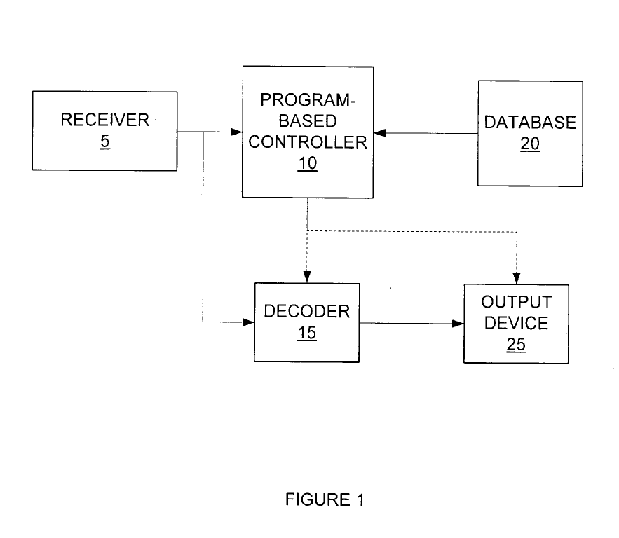

FIGS. 1-5 illustrate a method and system to configure, store, and apply user-selected operating characteristics for multimedia devices on a per-program basis. In one embodiment, the system provides a mechanism to link and apply the user-customized characteristics by means of program identification. The program identification can include a 16-bit field used to identify a particular program within a transport stream. In an embodiment, e.g., working in conjunction with an analog multimedia device, the system provides a mechanism to link and apply user-customized characteristics by means of a program name. The program name can be taken from a program guide source, e.g., the Internet, or by examining content associated with a program, such as vertical blanking interval (VBI) data. In an embodiment, operating characteristics which may be user-selected for setting modification are video characteristics such as brightness, contrast, aspect ratio, resolution, closed-captioning type, parental control features, and others, such as equipment supported features, e.g., CRT gamma value. In addition, audio operating characteristics that are user-selectable for modifications are volume level, language, tone, stereo, surround sound, and so forth. In a further embodiment, the operating characteristic includes recording options. Because the methodology presented herein applies the operating characteristics of multimedia devices on a per-program basis, the user no longer has to be concerned with which channel or carrier is broadcasting a particular program, as in conventional systems. The program settings can also be applied regardless of the program source, i.e., airwaves, the Internet, cable, fiber, satellite, etc.

A system to practice methods as disclosed herein could be implemented as shown in FIG. 1, which is a block diagram illustrating a system for managing user-customized settings associated with a multimedia device. The receiver 5 receives transmitted program information from a broadcast stream, including transmitted video and audio signals from a plurality of channels. The receiver selects a single channel of multimedia data. Decoder 15 then processes the single channel of multimedia data into video and audio data for output device 25. The source of the acquired program information may be transmitted to receiver 5 via cable, digital broadcast, terrestrial signals, satellite, videotape, audiotape, the Internet, digital video disc, laser disc, optical disk, or the like. A program-based controller 10 identifies, from the broadcast transmission, a desired program, and applies the user-selected program characteristics stored in database 20 to the desired output device 25. The user-selected program characteristics to modify are created and stored in database 20, which program-based controller 10 accesses to store and retrieve the user-supplied information to apply to a desired program. Output device 25 includes a multimedia device or set of devices the user will use to view, listen to or capture the desired program, for example, a television set, computer, or recording device.

As programs change within a same channel, the settings desired by a user can also change. Therefore, a program-based controller 10 can automatically apply settings based on the particular program being received. Program-based controller 10 monitors the broadcast stream data to determine if user-selected operating characteristics (e.g., video and audio parameters) stored in user-settings database 20 match the unique characteristics of a desired program, as discussed below. If a match is found, the user-selected operating characteristics from database 20 are applied to output device 25.

Program-based controller 10 can determine a unique characteristic of a desired program. The unique characteristic of the desired program could include program title, catalog number, broadcast channel, program provider, broadcast time, programming guide, event information table, or other means to identify a particular program. For example, an embodiment of the present disclosure may utilize the program channel and broadcast time to identify the particular program. Program controller 10 provides a means for a user to modify the settings of the desired program. For example, an interactive session wherein the user chooses which, if any, settings to modify may be conducted. Users may preferentially select as many or as few audio, video, or recording parameter settings to modify via program-based controller 10 as they wish, thus fully optimizing their multimedia entertainment experiences with diverse multimedia devices.

The current system offers the advantage of being able to apply desired operating parameter settings for any programs with settings stored in database 20 to any output device 25, regardless of local settings on output device 25. Thus many different types of programs, i.e., science fiction, sporting events, mysteries, documentaries etc., may have different user-created settings applied whenever a particular program is viewed (or recorded). Users may retrieve their stored settings for modification anytime they wish to amend their selections. In an embodiment, operating characteristics that may be user-selected for modification include video characteristics such as brightness, contrast, aspect ratio, resolution, closed-captioning type, and others In one embodiment, the operating characteristics include different video filtering and processing for different types of video content, such as cartoons, high motion sports, and news broadcasts, allowing video processing to be tailored to the type of program and improve video quality. In addition, audio operating characteristics that are user-selectable for modifications can include volume level, language, tone, stereo, surround sound, and so forth. In a further embodiment, the operating characteristic includes recording quality options. Other features such as parental control may be applied by program-based controller 10 upon user input.

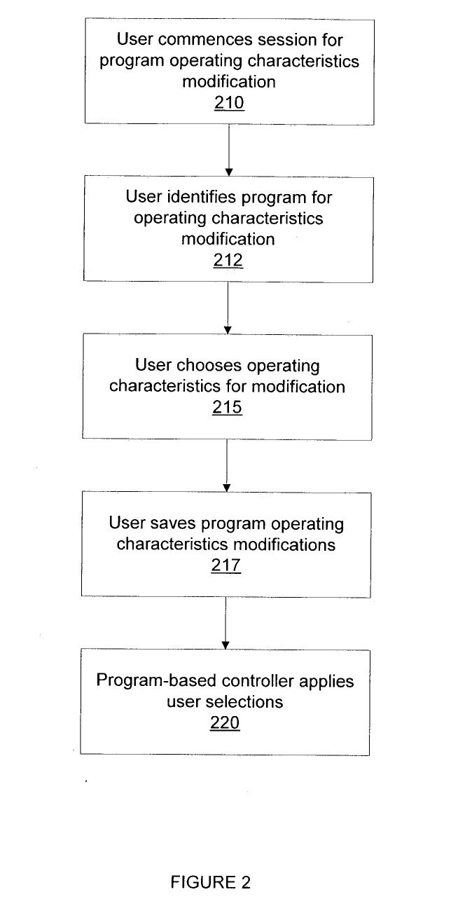

The flow of events according to the methodology taught herein is shown in FIG. 2, a flow diagram of a method to configure, store, and apply user-selected operating characteristics for multimedia devices on a per-program basis. In step 210, a user commences a session for program operating characteristics modification. The user's session may be conducted interactively via remote control device, or manually, or by keyboard or other pointing device, or by voice commands, e.g., for visually impaired users. During a session, the embodied method provides a user interface in the form of a table, menu, database, or other interactive presentation means to permit the user to locate and choose the desired program upon which to subsequently modify the operating characteristics.

The user selects (identifies) a program for operating characteristics modification in step 212. The program selected may be one that is currently being received, or one that is scheduled for future broadcast, or one that has been entered into a database in an earlier session. After the program is identified in step 212, further selections for video, audio, or recording options operating characteristics to modify are presented to the user. In step 215, the user chooses which operating characteristics to modify. A user may select one or many characteristics to modify, as supported by the user's multimedia equipment, i.e., valid options. Operating characteristics include video characteristics such as brightness, contrast, sharpness, soften, aspect ratio, resolution, closed captioning, and others, as well as audio characteristics such as volume, language, stereo, surround, and others. In addition, recording options are also available. As an example, a user could select to record a particular program on a video cassette recorder (VCR), or digital video recording device, at the highest available resolution or recording quality level.

The user saves the desired program operating characteristic modifications in a database in step 217. In step 220, the user-modified operating characteristics for the chosen program are applied by the program-based controller. If the program were currently tuned in, the settings would be applied immediately. If the program were not currently tuned in, the user-modified operating characteristics would be applied to future broadcasts of the program on the multimedia device, until otherwise altered by the user. It should be appreciated that other methods of identifying user preferences for particular programs can be used without departing from the scope of the present invention. In an alternate embodiment, user settings are automatically stored in the database. The settings a user applies during the presentation of a current program can be stored in the database automatically for future presentations of a program. Accordingly, user preferences may be identified without requiring the user to explicitly save settings for future presentations of a program. Furthermore, user preferences can be applied to playback of recorded programs. For example, the ser preferences can be applied during a playback of a recorded program, such as a program recorded using a VCR or a program recorded as a data file by a digital recording device, such as multimedia devices used for time-shifted playback. User preferences can be applied based on program identifiers stored with recorded program or the user preferences can be stored and accessed directly from the recorded program.

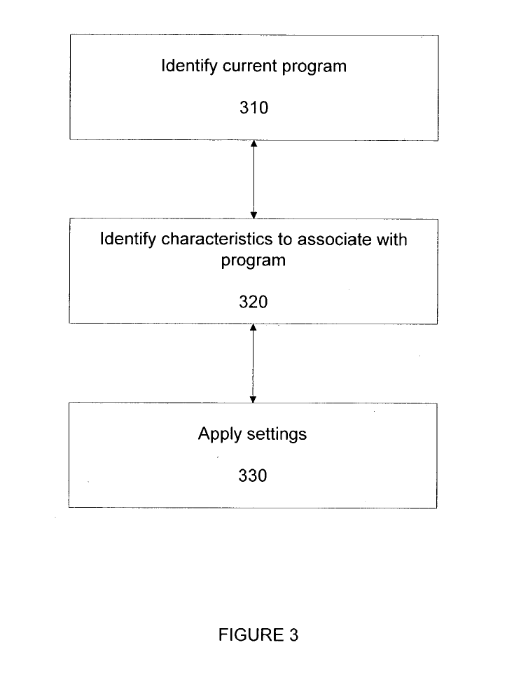

FIG. 3 is a flow diagram of a method for managing settings applied to a multimedia device according to an embodiment of the present disclosure. In the various embodiments, such as those discussed with reference to FIG. 3, a program-based multimedia device controller monitors multimedia signals, e.g., channel tuned-in, as selected by a user and transmitted to a multimedia device. Multimedia devices can include televisions, video display terminals, VCRs, digital video disk (DVD) devices, audio tape recorders, optical disk devices, compact disk (CD) devices, and the like. In step 310, the program-based multimedia device controller receives at least a portion of a multimedia program, and analyzes this data to determine if a unique characteristic (program identification) is present which matches previously stored user-selected program identification numbers and settings data. This unique characteristic can be based on at least one of the following: program title; catalog number, broadcast channel, program provider, broadcast time, programming guide, or event information guide. Alternatively, step 310 may also be applied during a live, interactive session in order to apply user-requested settings, which may then be stored to a database for utilization.

The program-based multimedia device controller monitors the signal for a unique characteristic, e.g., program identification (ID), and compares the program ID with a current session, or with previously stored session user input. If a match is found, the program-specific multimedia device controller identifies the user-specified characteristics (audio/video parameters and user settings) associated with the program in step 320. When a monitored program's identifier matches a program identifier chosen interactively or with stored user-selected choices, the user's modifications to the operating characteristics of a multimedia device are applied by the multimedia device controller in step 330. Whenever the multimedia device is operating (receiving a broadcast), the program-based multimedia device controller is monitoring for the presence of this unique characteristic. Anytime a match exists for program identifiers and user-requested modifications of operating characteristics, the device controller applies the user-selected modifications to the operating characteristics for the multimedia device, regardless of current local settings that may be in effect on the multimedia device.

Settings can also be applied to multimedia data presented in a time-shifted playback mode. Time-shifted playback refers to playback of recorded multimedia streams, such as multimedia streams recorded using a VCR or a digital video recording device. Accordingly, user preferences associated with an original program being recorded can be stored in a database for access in future playback or stored with the program being recorded. For example, a digital video recording device can store the user preferences along with a data file used to store multimedia data associated with the program. During time-shifted playback, the user preferences can be accessed and applied to the playback of the recorded multimedia stream. In another embodiment, user preferences can be applied to a program being recorded for time-shifted playback. Accordingly, the program being recorded will automatically reflect the user preferences during time-shifted playback with requiring a playback system to identify or access the user preferences. It should be appreciated that the methods described can be applied to other program types without departing from the scope of the present invention.

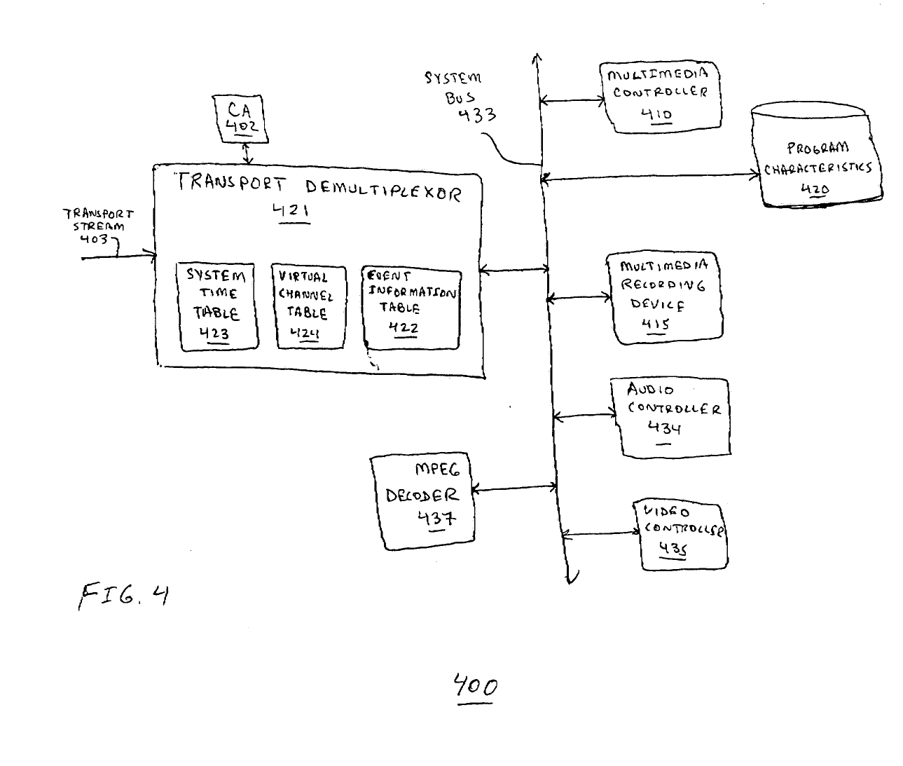

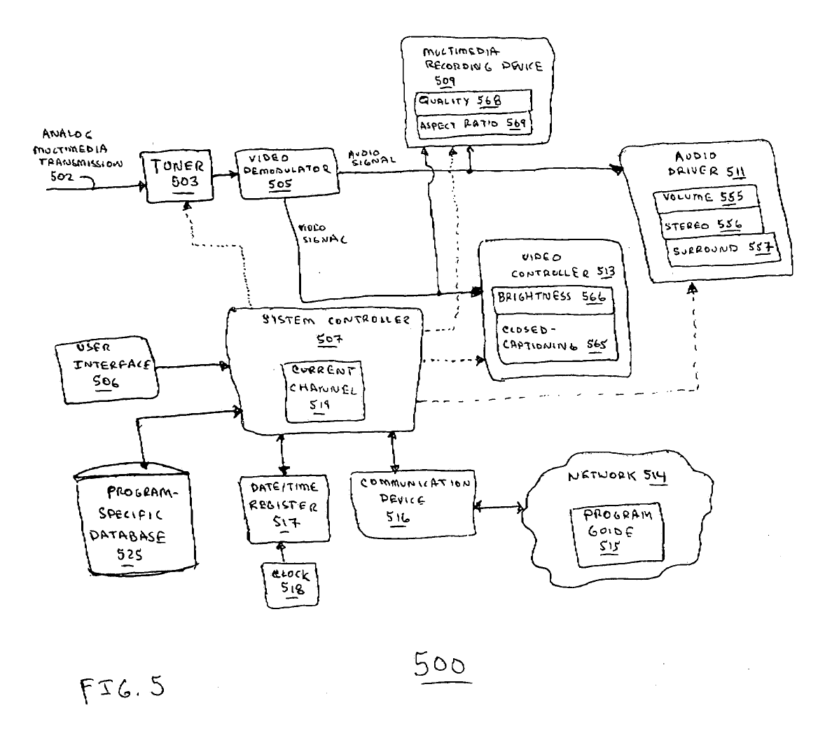

Representative systems to practice specific embodiments with regard to digital transmissions and analog transmissions are illustrated in FIGS. 4 and 5 respectively. FIG. 4 is a block diagram of a system 400 for receiving a digital signal to apply user-selected operating characteristics on a per-program basis to a multimedia device according to the teachings herein. Digital transport stream 403 is received by a transport demultiplexor/parser 421. Demultiplexor 421 contains various other entities such as system time table 423, event information table 422, and virtual channel table 424, as well as a connection to a conditional access module 402. A system bus 433 connects multimedia controller 410, program characteristics database 420, multimedia recording device 415, audio controller 434, video controller 435, and mpeg decoder 437 with demultiplexor 421 for operational functionality.

Transport demultiplexor 421 receives transport stream 403, and compares a request with the conditional access module 402. Conditional access module 402 can include a system for identifying decryption keys for processing some protected programs, e.g., pay-per-view. Generally, a smart card (not shown), connected to a smart card interface (not shown), will be accessed to identify valid programs for the subscriber. The smart card is used to decrypt keys that are, in turn, used to descramble channels using conditional access module 402. System time table 423 provides time, based on the received transport stream 403, to the various components making up system 400. Event information table 422 provides information for events or programs on virtual channels. Virtual channel table 424 provides attributes for all virtual channels in the received transport stream 403. Transport demultiplexor 421 provides mpeg video data related to a selected program to mpeg decoder 437.

Mpeg decoder 437 decodes mpeg video data received from transport stream 403 via demultiplexor 421, and generates video and audio data related to a selected program. Video data is provided to video controller 435 for display on a display device (not shown). Audio data is sent to audio controller 434. Audio controller 434 in turn provides the data to an audio receiver or to a speaker or speakers. In addition, audio/video data may be sent to other devices (not shown), such as a digital recording device, e.g., TiVo.

The multimedia controller 410 utilizes the system bus 433 to obtain information within the system 400. For example, multimedia controller 410 may use the system timetable 423, event information table 422, or virtual channel table 424 to determine when a program identification (ID) or time-based selection matches that of a user-modified selection. Multimedia controller 410 uses the information to access, via system bus 433, program characteristics database 420, multimedia recording device 415, audio controller/driver, or video controller/driver 435 in order to apply the user-modified operating characteristics. Multimedia controller 410 then applies the user-modified operating characteristics. As an example, if a user has selected a particular recording quality, brightness setting, and volume level for a multimedia recording device 415 for a particular program, multimedia controller 410 would apply these settings. That is, multimedia controller 410 would send the requested record quality settings to the recording device 415, the brightness level settings to the video controller 435 for application by the video output device, and the requested volume level to the appropriate audio controller 434 for application of the settings by the audio output device.

In an embodiment of the present disclosure, a user, utilizing multimedia device controller 410, may set up operating parameter preferences for a multimedia device for a particular program that may differ from other programs. For example, a user may choose to always have Star Trek programs broadcast and/or recorded at a particular brightness, contrast, resolution, sound quality, e.g., enable Dolby surround sound, and recording quality level. These settings would not, however, be applied to other sci-fi genre programs for the same or another multimedia device unless specifically requested by a user. A user may even specify “default” operating parameter settings for a particular device, that is, what the user desires the settings to be when a particular program is not being broadcast. Star Trek could be displayed/recorded with user-specified (user-optimized) operating characteristics applied by multimedia controller 410, while any other program would have the “default” settings applied.

FIG. 5 is a simplified block diagram of a system 500 for receiving an analog multimedia transmission 502 to apply user-selected operating characteristics as taught herein. System 500 has a tuner 503, video demodulator 505, system controller 507, multimedia recording device 509, audio driver 511, video controller 513, date/time register 517 and clock 518, program specific database 525, and communications device 516 connected to a network 514.

Tuner 503 receives analog multimedia transmission 502, and tunes to select a carrier signal of a particular channel identified by system controller 507. Tuner 503 provides a signal related to current channel 519 to video demodulator 505. Video demodulator 505 decodes an audio and video signals from the received signal. The audio signal is sent to audio driver 511 for output to speakers (not shown). Audio driver 511 is capable of setting the different properties for playing the audio signal, such as volume level 555, stereo 556, surround 557, and others. The video signal is provided to the video controller 513 for display. Video controller 513 is capable of setting the different properties of the video signal, such as closed captioning 565, brightness 566, contrast (not shown), and others. Video demodulator 505 may also send the audio and video signals to a multimedia recording device 509. Multimedia recording device 509 may be a DVD recorder, a video cassette recorder, a TiVo device, or other recording device. Multimedia device 509 is capable of adjusting various recording properties such as recording quality, 568, aspect ratio 569, and others.

System controller 507 determines the current channel 519 based upon selection by a user from user interface 506. System controller 507 communicates with program specific database 525 when determining whether to apply user-modified program operational characteristics to the current channel 519. In one embodiment, system controller 507 receives the date and time from a date/time register 517, and receives network program guide information 515 from a communication device 516. A program ID can be taken from the current program scheduled on the program guide information 515 and the current channel 519. Communication device 516 may be a modem, or other suitable means of obtaining network program guide information 515 for system controller 507. When program specific database 525 is consulted by system controller 507, if a match based on program identification from the current channel exists, the user-specified operating characteristics for audio and video parameters for a multimedia device or recorder 509 are applied. For example, if a user has stored in program-specific database 525 settings that Star Trek be recorded at the highest resolution, system controller 507 would send this information to multimedia recording device 509. The multimedia recording device 509 can then apply the user-requested settings, such as by modifying recording quality 568, regardless of the current local parameter settings on multimedia device 509. Other programs could be recorded at lower resolution or quality to save tape or space, if a user so desires.

The various functions and components in the present application may be implemented using an information-handling machine such as a data processor, or a plurality of processing devices. Such a data processor may be a microprocessor, microcontroller, microcomputer, digital signal processor, state machine, logic circuitry, and/or any device that manipulates digital information based on operational instruction, or in a predefined manner. Generally, the various functions, and systems represented by block diagrams are readily implemented by one of ordinary skill in the art using one or more of the implementation techniques listed herein. One embodiment of the system for managing multimedia device settings is shown in FIG. 4. Program-based multimedia device controller 410 may be an integral part of a system, or a separate processing system connected to another system externally. Such a system may include random access memory (RAM), read-only memory (ROM), wherein ROM could also be erasable programmable read-only memory (EPROM) or electrically erasable programmable read-only memory (EEPROM), or input/output (I/O) adapter for connecting peripheral devices such as disk units, tape drives, or other peripheral devices to the system bus. Program-based controller 410 enables the method as embodied by the present disclosure to be implemented as a set of instructions to be stored on a computer readable medium and executed by a multimedia device. It will be understood that the program-based multimedia device controller 410 may comprise other suitable data processing systems without departing from the scope of the present disclosure. When a data processor for issuing instructions is used, the instruction may be stored in memory. Such a memory may be a single memory device or a plurality of memory devices. Such a memory device may be a read-only memory device, random access memory device, magnetic tape memory, floppy disk memory, hard drive memory, external tape, and/or any device that stores digital information. Note that when the data processor implements one or more of its functions via a state machine or logic circuitry, the memory storing the corresponding instructions may be embedded within the circuitry that includes a state machine and/or logic circuitry, or it may be unnecessary because the function is performed using combinational logic.

The method and apparatus herein provides for a flexible implementation. Note also, that although an embodiment of the present invention has been shown and described in detail herein, along with certain variants thereof, many other varied embodiments that incorporate the teachings of the invention may be utilized and that logical, mechanical, chemical and electrical changes may be made without departing from the spirit or scope of the invention. Benefits, other advantages, and solutions to problems have been described above with regard to specific embodiments. However, the benefits, advantages, solutions to problems, and any element(s) that may cause any benefit, advantage, or solution to occur or become more pronounced are not to be construed as a critical, required, or essential feature or element of any or all the claims. Accordingly, the present invention is not intended to be limited to the specific form set forth herein, but on the contrary, it is intended to cover such alternatives, modifications, and equivalents, as can be reasonably included within the spirit and scope of the invention.

What is claimed is:

1. A method for managing multimedia device settings, comprising the steps of:
receiving a multimedia stream
identifying a received program of the multimedia stream;
identifying a set of characteristics associated with the received program; and
applying the set of characteristics to a presentation of the received program.

2. The method of claim 1, wherein the step of identifying the received program further includes determining a unique characteristic of the received program based on a program identification, wherein the unique characteristic includes one of the set comprising a program title, a catalog number, a broadcast channel, a program provider, a broadcast time, a programming guide, and an event information table.

3. The method of claim 1, wherein the step of identifying the set of characteristics associated with the received program includes:
accessing a database of operating characteristics associated with at least the receive program;
selecting at least one operating characteristic to modify.

4. The method of claim 3, wherein the operating characteristic includes a video characteristic.

5. The method of claim 4, wherein the video characteristic includes one of the set of video characteristics comprising brightness, contrast, sharpen, soften, aspect ratio, resolution, and closed captioning type.

6. The method of claim 3, wherein the operating characteristic includes an audio characteristic.

7. The method of claim 6, wherein the audio characteristic includes one of the set of audio characteristics comprising volume, language, stereo, and surround sound.

8. The method of claim 3, wherein the operating characteristic includes a parental control feature.

9. The method of claim 3, wherein the operating characteristic includes an option to record.

10. The method of claim 1, wherein the multimedia device includes one of the set comprising a video display terminal, a television, a videocassette recorder, a digital video disk device, a compact disk device, an audio tape recorder, and an optical disk device.

11. A method for managing multimedia device settings comprising the steps of:
tuning to a multimedia channel;
receiving at least a portion of a multimedia program on a multimedia device
determining a unique characteristic of the at least a portion of the multimedia program; and
modifying at least one characteristic of the multimedia device based upon the unique characteristic.

12. The method of claim 11, wherein the step of determining a unique characteristic includes determining a program identification.

13. The method of claim 11, wherein the step of modifying includes:
accessing a database to determine the operating characteristics to modify;
selecting at least one operating characteristic to modify.

14. The method of claim 13, wherein the operating characteristic includes video characteristics.

15. The method of claim 14, wherein the video characteristics include one of the set of video characteristics comprising brightness, contrast, aspect ratio, resolution, and closed captioning type.

16. The method of claim 13, wherein the operating characteristic includes audio characteristics.

17. The method of claim 16, wherein the audio characteristics include one of the set of audio characteristics comprising volume, language, and stereo surround sound.

18. The method of claim 13, wherein the operating characteristic includes a parental control feature.

19. The method of claim 13, wherein the operating characteristic includes a record option.

20. The method of claim 11, wherein the at least a portion of the multimedia program includes a time-shifted multimedia program.

21. The method of claim 20, wherein the step of receiving the at least a portion of the multimedia program includes playback of the time-shifted multimedia program from a data file.

22. A system for managing settings associated with a multimedia device, the system comprising:
a receiver to receive a multimedia signal;
a decoder to process the multimedia signal into multimedia data
a program-based controller to:
receive program information associated with a particular program of the multimedia signal; and
identify user-selected program characteristics for the particular program based on said program information;
a database associated with the program-based controller to store said user-selected program characteristics; and
an output device to present a representation of said multimedia data.

23. The system of claim 22, wherein a source of said program information includes one of the set of program information sources comprising cable, digital broadcast, terrestrial signals, satellite, and the Internet.

24. The system of claim 22, wherein the program-based controller further comprises:
a means to determine a unique characteristic of the particular program associated with the multimedia signal;
a means for a user to modify user-selected program characteristics associated with the particular program; and
a means to apply the user-selected program characteristics to a presentation of said particular program using said output device.

25. The system of claim 24, wherein the unique characteristic is based on one of the set of program characteristics including a program title, catalog number, program provider, broadcast time, programming guide, and event information table.

26. The system of claim 22, wherein the user-selected program characteristics of the particular program include video characteristics.

27. The system of claim 26, wherein the video characteristics include one of the set of video characteristics comprising brightness, contrast, aspect ratio, resolution, closed captioning type, and sharpness.

28. The system of claim 22, wherein the user-selected program characteristics include audio characteristics.

29. The system of claim 28, wherein the audio characteristics include one of the set of audio characteristics comprising volume, language, and stereo.

30. The system of claim 22, wherein the user-selected program characteristics include a parental control feature.

31. The system of claim 22, wherein the user-selected program characteristics include recording options.

32. The system of claim 31, wherein the recording options include a recording quality.

33. The system of claim 22, wherein the output device includes one of the set of multimedia devices comprising a video display monitor, a television set, an audio receiver, a video tape recorder, a digital video disk device, a compact disc device.
